(19) United States
(12) Patent Application Publication
(10) Pub. No.: US 2018/0347750 A1
(43) Pub. Date: Dec. 6, 2018

(54) Motorized Fluid Dispensing and Suction Apparatus

(71) Applicant: Ramon Arreola, Cypress, CA (US)

(72) Inventor: Ramon Arreola, Cypress, CA (US)

(21) Appl. No.: 15/242,551

(22) Filed: Aug. 21, 2016

Related U.S. Application Data
(63) Continuation of application No. 62/208,776, filed on Aug. 23, 2015.

(51) Int. Cl. F16N 3/12; B05C 17/01

(52) U.S. Cl. CPC F16N 3/12; B05C 17/014

(57) ABSTRACT

The invention relates to any field that requires suctioning and/or dispensing fluids of various viscosities (i.e. oil, grease or other like fluids) through a nozzle into a container or mechanical assembly (such as but not limited to robotic RV reducers used in industrial robotic arms, general purpose gearboxes used in various mechanical assemblies such as conveyors and internal combustion engines) for the purposes of transfer of fluids (such as but not limited to lubricating a system, injecting lubricant fluids into light and heavy industrial machines etc). This apparatus can be used in fluid transfer, dispensing and injection applications requiring monitoring of flow pressure and volume.

### 1. FIELD OF INVENTION

The invention relates to any field that requires suctioning and dispensing of fluids of various viscosities from and into a mechanical assembly and has the ability of using bulk grease loading at any angle. Predominantly, the present invention is in the technical field of suctioning and/or lubricating such fluids from the cavity of general purpose mechanical assemblies (i.e. robotic RV reducers used in industrial robotic arms, general purpose gearboxes used in various mechanical assemblies such as conveyors and internal combustion engines).

### 2. BACKGROUND (PROBLEMS)

Present day fluid dispensing and suctioning devises are not power driven and don't provide power driven control of pressure, volume or flow. Existing tools require manual physical force for dispensing the fluid and/or loading the gun with the fluid. The most common tools are the Caulking gun (U.S. Pat. No.: 2,768,768), the High viscosity oil suction and dispensing tool (U.S. Pat. No.: 8,181,829), and the Optional loading grease gun (U.S. Pat. No.: 3,059,819).

The Caulking gun (U.S. Pat. No.: 2,768,768) is used for dispensing, requires the use of pre-filled cartridges a lot of physical power for pushing the piston to dispense the fluid and its purpose per the patent description is to provide a simple and inexpensive calking gun which will completely eliminate after flow following gun operation. It cannot and is not intended to extract fluids from the end assembly.

The High viscosity oil suction and dispensing tool (U.S. Pat. No.8,181,829) requires the use of bulk grease which is filled through the use of physical force by pulling the triggers to the handle (manually pumping inwards) and pulling the piston to fill the cylinder. The fluid is dispensed and/or extracted through the use of physical power by pulling the triggers to the handle and pushing or pulling the piston to rotate the rod either in the forward or backward direction to fill or empty the cylinder. It is not a motorized handling operation.

The Optional loading grease gun (U.S. Pat. No.: 3,059,819) which provides the option of using cartridges or bulk grease, when using bulk grease it is filled through the use of physical force by pulling the piston to fill the cylinder. It is not a motorized handling operation.

### 3. SUMMARY (PROBLEM TO BE SOLVED)

The present invention seeks to provide a solution to present day fluid dispensing and suctioning devises that are not power driven and don't provide power driven nor selectable options for control of pressure, volume or flow. The present invention apparatus has the ability to suction and dispense fluids of various viscosities using a power train (such as but not limited to the use of a cordless drill motor, a software controlled system that consists of a servo motor, hydraulic or pneumatic rotating system which includes the use of a belt or gear type of assembly). This invention will dispense fluids of various viscosities using the pressure required by the receiving assembly; it is capable of dispensing to both low and high pressure environments. Regular fluid dispensing devises require manual physical force for either suction or dispensing of fluids and none provide power driven control of pressure, volume, or flow.

### DETAILED DESCRIPTION OF THE INVENTION/ABSTRACT

The invention relates to any field that requires suctioning and/or dispensing fluids of various viscosities (i.e. oil, grease or other like fluids) through a nozzle into a container or mechanical assembly (such as but not limited to robotic RV reducers used in industrial robotic arms, general purpose gearboxes used in various mechanical assemblies such as conveyors and internal combustion engines) for the purposes of transfer of fluids (such as but not limited to lubricating a system, injecting lubricant fluids into light and heavy industrial machines etc). This apparatus can be used in fluid transfer, dispensing and injection applications requiring monitoring of flow pressure and volume.

### BRIEF DESCRIPTION OF THE DRAWINGS

FIG. 1 is a side view of the Motorized Fluid Dispending and suction apparatus of the present invention.

FIG. 2 is side view of the pickup mechanism that attaches to the apparatus end device for suctioning the fluid into the apparatus.

FIG. 3 is side view of the delivery mechanism that attaches to the apparatus end device for dispensing the fluid out of the apparatus and into the receiving system.

### PREFERRED EMBODIMENT OF THE INVENTION This section will describe the present invention with references to the figures included.

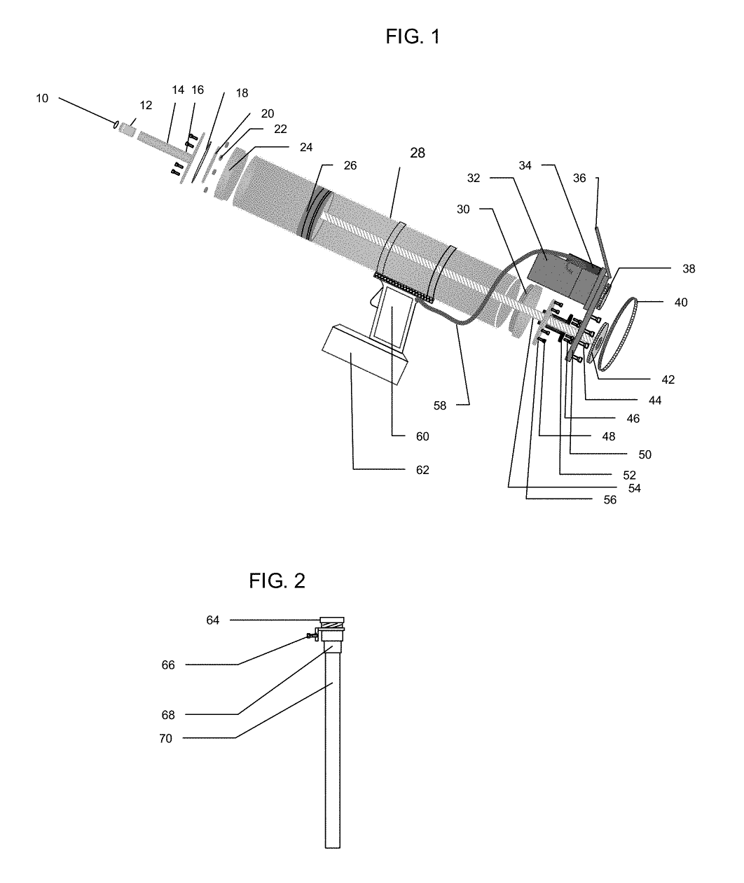

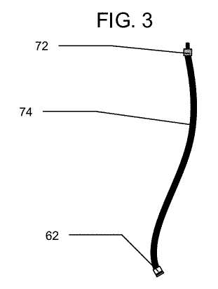

Referring to FIG. 1 ‘side view of the Motorized Fluid Dispending and suction apparatus of the present invention, FIG. 2 ‘side view of the pickup mechanism that attaches to the apparatus end device for suctioning the fluid and FIG. 3 is side view of the delivery mechanism that attaches to the apparatus end device for dispensing the fluid into the receiving system, and FIG. 4 ‘gear assembly’ which can be used in place of the belt-pulley assembly comprise the apparatus for suctioning and dispensing fluids of various viscosities. The dispensing and suctioning apparatus FIG. 1 comprises of a type of pump body 28 used for holding fluid. An O-ring 10 is placed around the male coupler 12 which are connected to the nozzle 14. Fluid is dispensed or suctioned via the nozzle 14. Screws 16 are used to connect the outlet assembly 24. In between the nozzle 14 and the outlet assembly 24, there is an o-ring 18, a large spacer 20 and small spacers 22 that are used to seal the connection between the nozzle 14 and the outlet assembly 24. The inside of the pump body 28 contains a piston assembly 26 which moves forward and backwards creating pressure to dispense or suction the fluid in the pump body 28. The drive assembly mount 30 is connected to the rear end of the pump body 28. The bearing 56 is attached to the drive assembly mount 30 by screws 48. The ball nut 52 and ball nut pulley 42 are connected to bearing 56 using screws 46. Ball nut pulley 42 is driven by the belt 40 and motor pulley 38. Motor 32 spins forward and reverse providing rotational motion on the pulley 38 which in turn rotates the attached belt 40 and ball nut pulley 42 resulting in the back and forth motion of piston 26. Controller 34 is used to control the rotation of motor 32. A liquid crystal display (LCD) 36 is used as an input device that commands the controller 34 on what actions to take. Pump body handle 60 is used for holding the apparatus. The power pack 62 is attached to the pump body handle 60. Power pack 62 powers the apparatus via the power cable 58. Power cable 58 is attached to the controller 34.

Referring to FIG. 2 ‘Side view of the pickup mechanism that attaches to the apparatus end device for suctioning the fluid into the apparatus,’ the FIG. 2 female coupler 64 couples with FIG. 1 male coupler 12 to provide a sealed connection for fluid transfer into the apparatus. FIG. 2 female coupler 64 is mounted to pickup bracket 66, pickup fitting 68 and pickup extension 70 allowing fluid to be transferred from a container into the apparatus.

Referring to FIG. 3 ‘Side view of the delivery mechanism that attaches to the apparatus end device for dispensing the fluid out of the apparatus and into the receiving system,’ the FIG. 3 female coupler 76 couples with FIG. 1 male coupler 12 to provide a sealed connection for fluid transfer out of the apparatus. FIG. 3 female coupler 76 is mounted to hose 74, and fitting 72 allowing fluid to be transferred to a receiving system.

What is claimed a motorized suctioning and/or dispensing fluid apparatus that consists of the following elements:

1. Container for holding fluid of various viscosities (not limited to cylindrical shape),
a power train (such as but not limited to the use of a cordless drill motor, a software controlled system that consists of a servo motor, hydraulic or pneumatic rotating system which includes the use of a belt or gear type of assembly) used to drive the apparatus,
a piston inside the apparatus driven by the power train,
a coupler at the front end of the nozzle for attaching to a pickup or deliver mechanism/device,
a pickup mechanism for suctioning the fluid into the apparatus,
a delivery mechanism for dispensing the fluid out of the apparatus.
Whereby said system can suction or dispense fluids of various viscosities from various types of fluid holding containers such as buckets, drums, or mechanical assemblies such as but not limited to gear boxes or robot axis cavities.

2. The invention of claim 1, a controller utilized for driving the power train.

3. The invention of claim 2, power train will have options to manually
control the volume, pressure and/or flow of the fluid being dispensed;
control the volume, pressure and/or flow of the fluid being suctioned.

4. The invention of claim 3 further comprising of a display or input device.

5. The invention of claim 4 wherein a software program is used command the controller.

6. The invention of claim 5, based on software option selected the controller will control the power train accordingly.

7. The invention of claim 6, display or input device will have options for
selecting the amount of fluid to be dispensed.

8. The invention of claim 7, display or input device will have options for
selecting the amount of fluid to be suctioned.

9. The invention of claim 8, display or input device will have options for
selecting the type of device that will be receiving the fluid based on model number or other options.

10. The invention of claim 9, display or input device will have options for
selecting the type of device from which fluid will be suctioned based on model number or other option.

11. The invention of claim 10, display or input device will have options for
selecting the volume, pressure and/or flow pressure to be applied when dispensing the fluid.

12. The invention of claim 11, display or input device will have options for
selecting the volume, pressure and/or flow pressure to be applied when suctioning the fluid.
